(19) United States
(12) Patent Application Publication
(10) Pub. No.: US 2022/0355138 A1
(43) Pub. Date: Nov. 10, 2022

(54) BATTERY ARRANGEMENT HAVING AN EXTINGUISHING AGENT SUPPLY DEVICE, MOTOR VEHICLE, AND METHOD FOR PROTECTING A BATTERY

(71) Applicant: AUDI AG, Ingolstadt (DE)

(72) Inventors: Dirk BAEDER, Fellbach (DE); Michael GRABOWSKI, Ingolstadt (DE)

(73) Assignee: AUDI AG, Ingolstadt (DE)

(21) Appl. No.: 17/706,906

(22) Filed: Mar. 29, 2022

(30) Foreign Application Priority Data
May 6, 2021 (DE) 102021111763.1

(51) Int. Cl. A62C 3/16; A62C 35/68

(52) U.S. Cl. CPC A62C 3/16; A62C 35/68

(57) ABSTRACT

A battery arrangement for a motor vehicle, having a battery and an extinguishing agent supply device for guiding an extinguishing agent at the extinguishing agent supply device to the battery. The extinguishing agent feed device has a first connector coupling to an extinguishing agent reservoir external to the motor vehicle, a second connector connected to at least one component of the battery, and a line from the first connector to the second connector. The line includes at least one first line section which, with respect to an intended installation position of the battery arrangement in the motor vehicle, has a positive slope in relation to a horizontal and with respect to an extension direction of the line from the first connector to the second connector; and/or the extinguishing agent supply device has a closure element having an active locking mechanism which is unlockable or lockable by an associated unlocking unit.

### FIELD

The invention relates to a battery arrangement for a motor vehicle, having a battery and an extinguishing agent supply device for supplying an extinguishing agent provided at the extinguishing agent supply device to the battery, wherein the extinguishing agent supply device has a first connector for coupling to an extinguishing agent reservoir external to the motor vehicle, a second connector which is connected to at least one component of the battery, and a line from the first connector to the second connector. The invention also relates to a motor vehicle having such a battery arrangement and a method for protecting a battery.

### BACKGROUND

Extinguishing agent systems are known from the prior art, as described, for example, in FR 2 991 258 A1. This system comprises a line leading from the battery to an outside of the vehicle. In case of a battery fire, for example, an extinguishing hose can be connected to this externally accessible line and extinguishing agent can be supplied to the battery to extinguish the battery. The battery is arranged in an underbody region of the motor vehicle, wherein the extinguishing agent line is led horizontally to the outside. Since the end of the extinguishing agent line is thus arranged very low, a closure element is provided to protect the battery from a penetration of liquid from the surroundings. This can be arranged inside the line. This closure element can be designed, for example, as a spring closure that is only opened from the outside when a certain pressure force is applied, for example by the introduced extinguishing agent, or as a bursting element that ruptures under the pressure of the extinguishing agent, or as a membrane that melts from a certain temperature.

Since the undesired penetration of liquid in the normal state of the battery can cause very great damage, particularly in the case of batteries designed as high-voltage batteries, it is nevertheless desirable to be able to further increase security in conjunction with such extinguishing agent supply devices.

### SUMMARY

The object of the present invention is therefore to provide a battery arrangement, a motor vehicle, and a method that make it possible to provide a particularly high degree of security with regard to an extinguishing agent supply device in order to prevent undesired penetration of liquid into the battery as efficiently as possible.

A battery arrangement according to the invention for a motor vehicle has a battery and an extinguishing agent supply device for supplying an extinguishing agent provided at the extinguishing agent supply device to the battery. The extinguishing agent supply device has a first connector for coupling to an extinguishing agent reservoir external to the vehicle, a second connector which is connected to at least one component of the battery, and a line from the first connector to the second connector. The extinguishing agent supply device has a closure element having an active locking mechanism that is unlockable or lockable by means of an associated unlocking unit, and/or the line has at least one first line section that has a positive slope in relation to a horizontal with respect to an intended installation position of the battery arrangement in the motor vehicle and with respect to an extension direction of the line from the first connector to the second connector.

An active locking mechanism can also be understood as a mechanism for mechanical locking or unlocking, which can be actuated, for example, by a fire department using a specific key or by manual actuation after removing a protective cap, for example. An electrical or electronic activation does not necessarily have to be provided for unlocking and/or locking.

A positive slope with respect to the horizontal is to be understood in relation to an intended installation position of the battery arrangement in a motor vehicle, in particular at least when the motor vehicle is located on an approximately horizontally oriented surface. Furthermore, the extension direction of the line from the first to the second connector also simultaneously defines an intended flow direction when the battery is flooded from the outside via the first connector into the interior of the battery via the second connector. Thus, the first line section extends in the extension direction from bottom to top with respect to a direction of gravity.

The invention is based on the finding that with externally accessible connectors of extinguishing agent supply devices, there is not only the risk that liquid from the surroundings can inadvertently penetrate, but also the risk of vandalism or misuse. In the case of a completely unprotected extinguishing agent supply device, in particular an exposed line leading to the outside, possible misuse is possible using comparatively simple means, for example, by a passerby gaining access to the openings and pouring a liquid such as coffee, cola, or the like into the battery. This can have serious consequences, up to thermal propagation due to short circuits and a resulting battery fire. Passive closure elements, such as those used in the prior art, can typically still be opened comparatively easily. In contrast, a clear advantage can be achieved by the invention in terms of security, since both a closure element having an active locking mechanism, on the one hand, and a line having a positive slope at least in regions, on the other hand, make it significantly more difficult to intentionally supply liquid into the battery. If, for example, the line in the first line section has a positive slope in the extension direction from the first connector to the second connector, to overcome this slope, it is necessary to fill the first connector using a certain minimum quantity of liquid or the liquid at a certain minimum pressure, so that it can get into the battery at all. This is possible without any problems when the fire department is supplying extinguishing agents, for example water, for example through a fire hose connected to the first connector, but it efficiently prevents other liquids such as cola, coffee or also solids from being able to get into the battery when they are poured into the first connector. Likewise, the fluidic connection from the first connector to the second connector can also be reliably interrupted by a closure element having an active locking mechanism. Such a closure element can in principle be arranged at any desired position from the first to the second terminus element and, for example, close the first connector directly from the outside or can also be arranged somewhere inside the line. A separate unlocking unit is therefore required to open and/or close or to unlock and/or lock this closure element, as a result of which the risk of misuse can be reduced to a minimum. Such an unlocking unit can accordingly only be assigned to authorized persons or institutions. For example, the filler neck provided by the first connector is locked using a special key that can only be opened by the fire department. Accordingly, unauthorized persons have no possibility of opening the locked closure element, at least not without damage and without the use of force.

The battery can represent a high-voltage battery for the motor vehicle. The battery can also include a battery housing and one or more battery cells accommodated therein. The first connector of the extinguishing agent supply device is preferably provided in an arrangement on the motor vehicle such that this connector is accessible from outside the motor vehicle. This makes it possible for rescue personnel, such as the fire department, to be able to easily connect an extinguishing hose or the like to this first connector in order to extinguish the battery in an emergency. The first connector can furthermore optionally be provided with a corresponding coupling mechanism, but this does not necessarily have to be the case. In the simplest case, a first connector can also be understood as a type of pipe socket or hose end or the like. The second connector is arranged on at least one component of the battery, wherein this component can represent, for example, the battery housing mentioned above or also a module housing of a battery module accommodated in the battery housing, in which multiple battery cells are in turn accommodated, or also an extinguishing agent distribution device, which permits a distribution of the extinguishing agent over the individual cells of the battery, in particular by way of a branching channel system. It is preferred that the extinguishing agent supply device is designed such that an extinguishing agent is introducible directly into the interior of the battery or its battery modules, so that the extinguishing agent can be brought into direct contact with the battery cells. A particularly efficient suppression of thermal propagation can thereby be provided. Accordingly, the extinguishing agent supply device can also be referred to as a flooding device, since it can be used to flood the battery by way of the extinguishing agent that it supplies to the battery. Nevertheless, it is additionally or alternatively also conceivable for the extinguishing agent to be supplied only to a type of outer shell or outer housing around the battery, which encloses the battery modules or battery cells, in particular into a flooding space that can be separated from the interior of the battery or the battery modules. The line can furthermore be provided as a rigid and/or flexible line. This can be designed, for example, as a hose and/or pipe or the like. The line can also have differently designed line sections. The first and second connector can also be defined simply as the corresponding line ends, for example.

In order to be able to increase the extinguishing agent throughput when extinguishing the battery, it is also advantageous if the battery arrangement furthermore has an extinguishing agent outlet or a corresponding extinguishing agent discharge device. This can also be designed, for example, as a discharge line from the battery to the outside, for example to a third connector, which can also be arranged so that it is accessible from outside the motor vehicle. The extinguishing agent supplied to the battery for extinguishing purposes can accordingly drain out again through such an extinguishing agent discharge device. Since such an extinguishing agent discharge line also has a corresponding access from the outside, the protective measures described for the extinguishing agent supply device can also be implemented in a very analogous manner for such an extinguishing agent discharge device. Furthermore, such an extinguishing agent supply device and extinguishing agent discharge device can each assume a dual function and, for example, can each be designed to supply an extinguishing agent and/or discharge an extinguishing agent from the battery. In other words, an extinguishing agent supply device can alternatively also be used for discharging the extinguishing agent, while an extinguishing agent discharging device arranged at a different position is used instead for supplying the extinguishing agent. In an emergency situation, the fire department can then advantageously choose the simplest access to supply the extinguishing agent on the vehicle.

In one advantageous embodiment of the invention, the line is designed to rise monotonously in the extension direction, at least for the most part, in particular completely. In other words, the line can extend uphill from the first connector arranged on the outside to the second connector. The slope can, but does not necessarily have to, be constant. This can be provided most simply, for example, by a pipe extending upwards from the first to the second connector. Pouring in a liquid as part of an attempted misuse accordingly has no effect, as it would immediately flow out of the first connector again. This variant is particularly advantageous since it can be implemented in a particularly simple and cost-effective manner and without any additional components. In particular, this can provide a protective effect for the battery without having to provide any type of additional device, for example, a closure element.

In a further very advantageous embodiment of the invention, the line has at least one second line section, which is arranged in front of the first line section in the extension direction and which has a negative slope in relation to the horizontal and with respect to the extension direction, so that at least one depression is provided between the first and second line section. Such a depression can advantageously be used to collect liquid therein. The line can be designed similarly to a siphon, for example. If the supply line is designed in the form of a siphon, for example, small amounts of liquids and solids that are introduced into the line through the first connector also cannot get into the battery. Instead, these collect in the at least one depression and cannot continue to flow due to the subsequent positive slope of the first line section. Such a barrier could eventually be overcome only if larger quantities were poured in. Accordingly, it is advantageous, for example, to form the collection capacity provided by the at least one depression having a volume of at least one liter, preferably at least five liters. The line can not only have a type of U-shaped geometry analogous to a siphon, but in principle also any other labyrinthine geometry that provides at least one depression. Such a protective mechanism for the battery can also be implemented in a particularly simple and cost-effective manner, since no additional components, such as closure elements or the like, are required here either.

In a further very advantageous embodiment of the invention, a hole is arranged in the line. Such a hole represents an opening in the line to the outside, i.e., from an interior of the line to an outside region surrounding the line. Such a hole is preferably made relatively small and can, for example, have an area which is preferably smaller than a cross-sectional area of the line in the region of the hole. It is particularly advantageous if such a hole is arranged between the first and second line section, that is to say in the region of the at least one depression. Advantageously, small amounts of liquids or solids can be discharged through such a hole. Accordingly, the depression also does not have to be dimensioned large in terms of its collection capacity in order to be able to prevent large volumes from penetrating into the battery. The opening or the hole can, for example, be dimensioned so small that the media loss at high inlet pressures, as is the case, for example, when supplying an extinguishing agent via a fire hose for extinguishing purposes, is negligible. Such a hole accordingly allows the battery to be protected even more efficiently, since very large amounts of liquid can be poured into the first connector in the event of an attempt at misuse without being able to get into the battery since it drains out through the hole in the depression.

In one advantageous refinement of the invention, the line can also have a closure element for closing the hole in case of fire. This can be represented as a second closure element different from the first closure element. For example, such a hole can be designed as a closable valve, which can then only be closed by the fire department, for example, and normally always remains open. In this way, media loss can be avoided in case of extinguishing. In addition, the hole can also be made larger in this case in order to prevent liquids from penetrating into the battery even more efficiently in the context of an attempt at misuse. If the line has such a closable hole, it does not necessarily have to be arranged in the above-mentioned depression. In principle, the hole can also be arranged in a line section having negative slope in the extension direction. With sufficient size, due to such an opening, any liquid or also solids introduced through the first connector cannot get into the battery as long as the hole is open. In this case, in order to protect the battery, it is not even necessary to design the line having a positive slope in the extension direction in some regions. Such a hole can then also be provided, for example, by the above-mentioned first closure element having the active locking mechanism. In other words, the closure element for closing the hole can represent the first closure element, which can only be closed and/or opened using the associated unlocking device.

In a further advantageous embodiment of the invention, the first closure element is designed as an actively activatable valve, wherein the battery arrangement comprises the unlocking unit, which is designed to detect a specific fault in the battery and to open the valve depending on the detected specific fault. In this case, the first closure element is not provided for closing the above-described hole, but normally, i.e., if there is no predetermined fault, closes the passage through the line from the first to the second connector, in particular at any point. If there is a specific fault of predeterminable, definable specific faults, the valve is opened by activation. Such a specific fault can represent, for example, exceeding a predetermined limiting temperature inside the battery, for example 60° or 70°, detecting smoke and/or fire in the battery, or also only detecting a short circuit or the like. In such a case, the activatable valve can now advantageously be actively activated by the unlocking unit in order to open. An extinguishing device for extinguishing the battery can then be connected to the first connector, since the fluidic connection is now released. The valve can be designed to be electrically and/or mechanically and/or pneumatically activatable. The unlocking unit can additionally comprise a control device for activating the valve. This can, for example, receive a detection signal from another control unit or detection unit for detecting the specific fault and as a result can activate the valve in order to open it.

It is also advantageous if the valve is arranged, for example, inside the line or at least at a position different from the first connector. It is thus arranged in a relatively protected position and thus cannot easily be broken open or damaged from the outside. Such an activatable valve advantageously ensures that it only opens when there is also a specific fault in the battery. In all other cases, it remains closed and thus represents very good protection against vandalism and misuse. Even if a liquid is supplied to the first connector at high pressure, it can be ensured in such a case that this liquid cannot get into the battery when the valve is closed.

In a further advantageous embodiment of the invention, the first closure element has a coupling device for mechanical coupling to the unlocking device. Such an unlocking device can function, for example, as a key, using which the closure element can be opened or initially unlocked. However, it is particularly advantageous in this embodiment above all that a coupling mechanism can be combined with the unlocking mechanism. This makes it possible, for example, to integrate the unlocking device into an extinguishing instrument of the fire department, for example into the coupling connector of the fire hose for coupling to the first connector of the extinguishing agent supply device. The extinguishing apparatus of the fire department can, for example, dock onto the filler neck according to a key-lock principle, which accordingly only lets media flow through when the correct extinguishing apparatus is docked. In other words, the docking and coupling mechanism is used to unlock the closure element at the same time. A particularly high degree of security can also be provided in this way.

Furthermore, the invention also relates to a motor vehicle having a battery arrangement according to the invention or one of its designs. The advantages mentioned for the battery arrangement according to the invention and its designs thus apply similarly to the motor vehicle according to the invention.

The motor vehicle according to the invention is preferably designed as an automobile, in particular as a passenger car or truck, or as a passenger bus or motorcycle.

According to a further advantageous embodiment of the invention, it is provided that the first closure element represents a tank and/or charging connector flap of the motor vehicle, by means of which the first connector and a tank and/or charging connector of the motor vehicle can be covered from the outside. In other words, the first connector of the extinguishing agent supply device can also be integrated under the tank or charging flap. This is typically lockable by the vehicle key, by which a protective mechanism for protecting the access to the first connector can also be provided at the same time.

In addition, it should also be noted that the above-described protective mechanisms are also combinable with one another in any way.

The invention also relates to a method for protecting a battery of a battery arrangement, using an extinguishing agent supply device for guiding an extinguishing agent provided at the extinguishing agent supply device to the battery, wherein the extinguishing agent supply device has a first connector for coupling to an extinguishing agent reservoir external to the motor vehicle, a second connector which is connected to at least one component of the battery, and a line from the first connector to the second connector. The line has at least one line section that has a positive slope in relation to a horizontal with respect to an intended installation position of the battery arrangement in the motor vehicle and with respect to an extension direction of the line from the first connector to the second connector, so that a liquid supplied to the first connector is only supplied to the battery from a certain minimum amount and/or at a certain minimum pressure, and/or the extinguishing agent supply line has a closure element having an active locking mechanism, which is unlocked or locked by means of an associated unlocking unit. The unlocking or locking preferably only takes place in a specific emergency or fault, for example triggered by the fire department or a detection device for fire detection or the like.

The invention also includes refinements of the method according to the invention, which have features as have already been described in conjunction with the refinements of the battery arrangement according to the invention. For this reason, the corresponding refinements of the method according to the invention are not described again here.

The invention also comprises combinations of the features of the described embodiments. The invention also comprises implementations that each have a combination of the features of several of the described embodiments, provided that the embodiments were not described as mutually exclusive.

### BRIEF DESCRIPTION OF THE FIGURES

Exemplary embodiments of the invention are described hereinafter. In the figures:

FIG. 1 shows a schematic illustration of a motor vehicle having a battery arrangement, which has an extinguishing agent supply device according to a first exemplary embodiment of the invention;

FIG. 2 shows a schematic illustration of a motor vehicle having a battery arrangement, which has an extinguishing agent supply device according to a second exemplary embodiment of the invention; and

FIG. 3 shows a schematic illustration of a motor vehicle having a battery arrangement, which has an extinguishing agent supply device according to a third exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those illustrated. Furthermore, the described embodiments can also be supplemented by further ones of the above-described features of the invention.

In the figures, the same reference signs designate elements that have the same function.

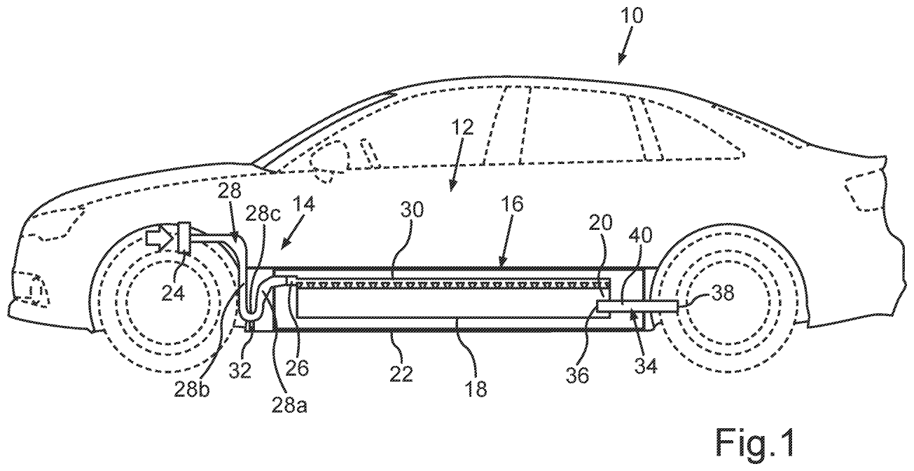

FIG. 1 shows a schematic illustration of a motor vehicle 10 having a battery arrangement 12, which comprises an extinguishing agent supply device 14 according to a first exemplary embodiment of the invention. In addition to the extinguishing agent supply device 14, the battery arrangement 12 has a battery 16, which is designed as a high-voltage battery 16 in the present example. In this example, the battery 16 has an inner battery housing 18, in which one or more battery cells 20 are arranged. This inner battery housing 18 can in turn be encased by an outer housing 22. The extinguishing agent supply device 14 also has a first connector 24, a second connector 26, and a line 28 which connects the first and second connectors 24, 26 to one another. The first connector 24 is arranged on the motor vehicle 10 in such a way that it is accessible from outside the motor vehicle, at least for authorized persons. In this case, the second connector 26 is coupled to at least one component of the battery 16. In this example, the second connector 26 is arranged with a distribution device 30 which, for example, can also provide a battery cover of the housing 18 or can be arranged under such a housing cover. For example, extinguishing agent can be supplied to the battery 16 via the second connector 26, so that it is introducible directly into the interior of the inner battery housing 18 and, in particular, can be brought into direct contact with the battery cells 20.

In order to make it easier for the fire department or other rescue personnel to supply extinguishing agent through the first connector 24, this is, as already mentioned, arranged so that it is externally accessible. With conventional extinguishing supply devices, this poses a risk of possible misuse, for example, in that a liquid is poured through such an opening, which could get into the battery and then could cause severe damage therein.

Possibilities are now advantageously disclosed by the invention or embodiments for being able to provide an anti-misuse device, using which third parties and unauthorized persons can be prevented from gaining direct access to the high-voltage battery 16 using simple means and possibly introducing foreign media or objects there or opening the access for living beings, for example mice or insects.

According to a first exemplary embodiment, as shown in FIG. 1, the line 28, which represents a supply line, is designed in the form of a siphon so that small amounts of liquids and solids cannot get into the battery. The line 28 thus has a first line section 28a, which has a positive slope in an extension direction from the first connector 24 to the second connector 26. Furthermore, the line 28 also has a second line section 28b, which has a negative slope in this extension direction. As a result, a depression 28c is provided between the first and second section 28a, 28b, in which liquids that are supplied by unauthorized persons through the first connector 24 of the extinguishing agent supply device 14 would then accordingly collect. As an alternative to this siphon geometry, however, other labyrinthine geometries can also be used. For example, multiple such depressions 28c can also be provided by a suitable geometric formation of the line 28. It is also particularly advantageous if the line 28 additionally has an emergency drain valve 32, as is also shown in this example. In the simplest case, this emergency drain valve 32 can simply be in the form of a small hole in the line 28. Small volumes of liquids or solids can be discharged through such a valve 32. The opening provided by this valve 32 can be dimensioned so small that the loss of media is negligible at high inlet pressures, for example if extinguishing agent is supplied to the first connector 24 by the fire department, or the valve 32 is designed to be closable and is then, for example, only to be closed by authorized persons or, for example, only by the fire department. In this way, a particularly efficient protection of the battery 16 can be provided since, for example, due to the corresponding geometric design of the line 28, no additional components to be provided separately are necessary.

Furthermore, the battery arrangement 12 can also have a corresponding extinguishing agent discharge device 34. This can also comprise a third connector 36, which is coupled to at least one component of the battery 16, and a fourth connector 38, which is also arranged so that it is accessible from outside the motor vehicle 10, and a line 40 connecting the third and fourth connectors 36, 38. In this example, this line 40 is thus led horizontally to the outside out of the vehicle 10 from the battery 16. Nevertheless, the measures described for the extinguishing agent supply device 14 and in particular in relation to the line 28 can also be implemented very analogously for this discharge line 40. The variants described hereinafter for protecting the battery 16 can also be implemented analogously for such an extinguishing agent discharge device 34.

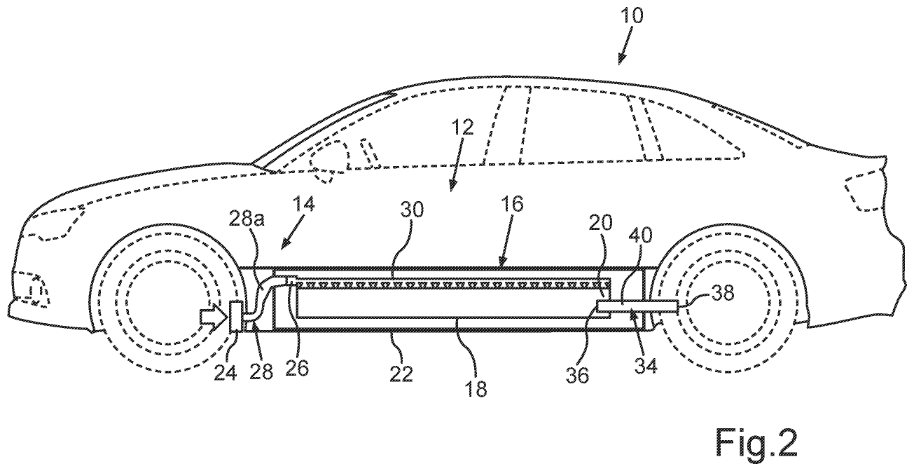

FIG. 2 shows a schematic illustration of a motor vehicle 10 having a battery arrangement 12 according to a further exemplary embodiment of the invention. In general, the battery arrangement 12 can be configured as already described in relation to FIG. 1, except for the differences described hereinafter, which relate above all to the design of the line 28 of the extinguishing agent supply device 14. The line 28 has a first line section 28a having a positive slope viewed in the extension direction in this example as well. In this example, however, the line 28 as a whole is designed to be continuously monotonically rising in the extension direction. This has the result that the filler of the flooding device or the extinguishing agent supply device 14 has to work against gravity or the water column, which means that only media having high inlet pressures, in particular above a limiting value dependent on the rise height, can get into the battery 16. Media poured in without pressure would therefore flow out of the line 28 again due to the force of gravity. This also makes it possible to provide protection for the battery 16 that is particularly advantageous and can be implemented easily and cost-effectively.

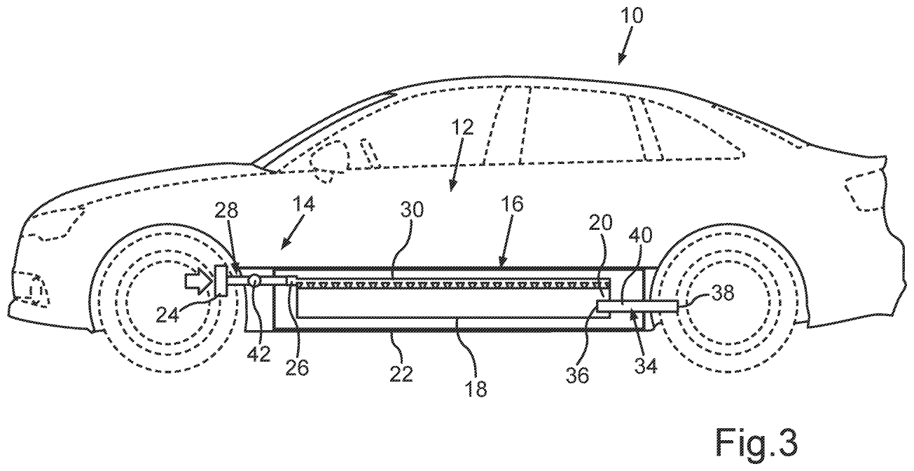

FIG. 3 shows a schematic illustration of a motor vehicle 10 having a battery arrangement 12 and an extinguishing agent supply device 14 according to a third exemplary embodiment of the invention. The battery arrangement 12 can be designed as described above in this example as well, except for the differences described hereinafter, which again relate fundamentally to the extinguishing agent supply device 14 and in particular to the design of the line 28. In this example, the geometric design of the line 28 is in principle irrelevant. Nevertheless, although the line 28 is shown here extending horizontally, it may also be, for example, designed like a siphon or having a continuously positive slope, as previously described. In this example, the line 28 now advantageously has a closure element 42 which comprises an active locking mechanism. As shown, this closure element 42 can be arranged in the region of the line 28, i.e., somewhere between the first connector 24 and the second connector 26, or for example also directly at the first connector 24 or second connector 26. This closure element is now advantageously designed to close line 28 at the point at which it is located. In this case, this closure element can also be arranged completely outside of the line 28 and can be designed, for example, as a tank and/or charging connector cover. This can be used to cover and lock a tank neck and/or a charging connector of the motor vehicle 10. The first connector 24 for the extinguishing agent supply device 14 can then advantageously also be provided in this region at the same time, so that a particularly efficient protective mechanism for the battery 16 is provided by this double function. Such a tank cap or charging connector cap is typically lockable, for example using a vehicle key. Such unlocking can, for example, also be carried out via an operating element in the vehicle 10 itself. It is also conceivable that such a flap can be unlocked by the fire department by way of a suitable transponder or the like. Alternatively or additionally, however, such a closure element 42 can also be located within the line 28 or can be arranged directly on the filler neck 24. For example, the filler neck 24 can have a separate closable flap or the like. The filler neck 24 can then only be closed and opened using a special key, for example, which can only be provided to the fire department, for example. It is thus possible that only the fire department is able to open this closure device or the closure element 42. Alternatively or additionally, the extinguishing apparatus of the fire department can also dock in the key-lock principle on the filler neck 24 on which this closure element 42 is arranged, which only lets media through if the correct extinguishing apparatus docks. In other words, the locking mechanism can be coupled to a specific coupling mechanism for docking the extinguishing apparatus. The correct coupling also unlocks the closure element 42 at the same time and it can be opened or opens automatically as a result. In a further example, this closure element 42 can also be designed as an actively activatable valve, for example electrically and/or mechanically and/or pneumatically activatable. Activation can be taken over, for example, by a control device (not shown here), which is designed to detect at least one predetermined fault of the battery 16 and as a result to activate the valve to open. These protective measures can also be combined with each other as desired and moreover can also be combined with other protective measures. For example, it is additionally conceivable that a closure mechanism is integrated in the supply line 28, which is designed, for example, as a safety fuse and/or pressure control element. In this way, security can be further increased.

Overall, the examples show how the invention can prevent misuse for the battery flooding device, which is represented in the present case by the battery arrangement and its extinguishing agent supply device, by which it is advantageously possible to preclude vandalism and misuse, and thus the possibility of damaging a vehicle via misuse can also be precluded. In addition, the fire department and rescue services still have direct access to the battery. Due to the increase in security, an advantage can also be achieved with respect to an insurance rating.

1. A battery arrangement for a motor vehicle, comprising: a battery and an extinguishing agent supply device for guiding an extinguishing agent provided at the extinguishing agent supply device to the battery, wherein the extinguishing agent supply device has:
a first connector for coupling to an extinguishing agent reservoir external to the motor vehicle;
a second connector which is connected to at least one component of the battery; and
a line from the first connector to the second connector;
wherein
the line has at least one first line section which, with respect to an intended installation position of the battery arrangement in the motor vehicle, has a positive slope in relation to a horizontal and with respect to an extension direction of the line from the first connector to the second connector; and/or
the extinguishing agent supply device has a closure element having an active locking mechanism which is unlockable or lockable by an associated unlocking unit.

2. The battery arrangement as claimed in claim 1, wherein the line is designed to rise monotonously in the extension direction, at least for the most part, in particular completely.

3. The battery arrangement as claimed in claim 1, wherein the line has at least one second line section which is arranged before the first line section in the extension direction and which has a negative slope with respect to the extension direction, so that at least one depression is provided between the first and second line section.

4. The battery arrangement as claimed in claim 1, wherein a hole is arranged in the line, preferably between the first and second line sections.

5. The battery arrangement as claimed in claim 4, wherein the line has the first or a second closure element for closing the hole in case of fire.

6. The battery arrangement as claimed in claim 1, wherein the first closure element is designed as an actively activatable valve, wherein the battery arrangement comprises the unlocking unit, which is designed to detect a specific fault in the battery and to open the valve depending on the detected specific fault.

7. The battery arrangement as claimed in claim 1, wherein the first closure element has a coupling device for mechanical coupling to the unlocking device, which is integrated in particular in an extinguishing instrument of the fire department and/or a separate key of the fire department.

8. A motor vehicle having a battery arrangement as claimed in claim 1.

9. The motor vehicle as claimed in claim 8, wherein the first closure element represents a tank and/or charging connector flap of the motor vehicle, by which the first connector and a tank and/or charging connector of the motor vehicle can be covered from the outside.

10. A method for protecting a battery of the battery arrangement having an extinguishing agent supply device for guiding an extinguishing agent provided at the extinguishing agent supply device to the battery, wherein the extinguishing agent supply device has:
a first connector for coupling to an extinguishing agent reservoir external to the motor vehicle;
a second connector which is connected to at least one component of the battery; and
a line from the first connector to the second connector;
wherein
the line has at least one line section which, with respect to an intended installation position of the battery arrangement in the motor vehicle, has a positive slope in relation to a horizontal and with respect to an extension direction of the line from the first connector to the second connector, so that a liquid supplied to the first connector is only supplied to the battery from a certain minimum amount and/or at a certain minimum pressure; and/or
the extinguishing agent supply device has a closure element having an active locking mechanism which is unlockable or lockable by an associated unlocking unit.

11. The battery arrangement as claimed in claim 2, wherein the line has at least one second line section which is arranged before the first line section in the extension direction and which has a negative slope with respect to the extension direction, so that at least one depression is provided between the first and second line section.

12. The battery arrangement as claimed in claim 2, wherein a hole is arranged in the line, preferably between the first and second line sections.

13. The battery arrangement as claimed in claim 3, wherein a hole is arranged in the line, preferably between the first and second line sections.

14. The battery arrangement as claimed in claim 2, wherein the first closure element is designed as an actively activatable valve, wherein the battery arrangement comprises the unlocking unit, which is designed to detect a specific fault in the battery and to open the valve depending on the detected specific fault.

15. The battery arrangement as claimed in claim 3, wherein the first closure element is designed as an actively activatable valve, wherein the battery arrangement comprises the unlocking unit, which is designed to detect a specific fault in the battery and to open the valve depending on the detected specific fault.

16. The battery arrangement as claimed in claim 4, wherein the first closure element is designed as an actively activatable valve, wherein the battery arrangement comprises the unlocking unit, which is designed to detect a specific fault in the battery and to open the valve depending on the detected specific fault.

17. The battery arrangement as claimed in claim 5, wherein the first closure element is designed as an actively activatable valve, wherein the battery arrangement comprises the unlocking unit, which is designed to detect a specific fault in the battery and to open the valve depending on the detected specific fault.

18. The battery arrangement as claimed in claim 2, wherein the first closure element has a coupling device for mechanical coupling to the unlocking device, which is integrated in particular in an extinguishing instrument of the fire department and/or a separate key of the fire department.

19. The battery arrangement as claimed in claim 3, wherein the first closure element has a coupling device for mechanical coupling to the unlocking device, which is integrated in particular in an extinguishing instrument of the fire department and/or a separate key of the fire department.

20. The battery arrangement as claimed in claim 4, wherein the first closure element has a coupling device for mechanical coupling to the unlocking device, which is integrated in particular in an extinguishing instrument of the fire department and/or a separate key of the fire department.
